(19) United States
(12) Patent Application Publication
(10) Pub. No.: US 2003/0031797 A1
(43) Pub. Date: Feb. 13, 2003

(54) Method for making an enamelled metal part without degreasing

(76) Inventors: Christophe Delmotte, Saussett Les Pins (FR); Philippe Legros, Istres (FR); Thierry Malot, Residence les Arenes (FR); Patrick Nicoletti, Ensues (FR)

Correspondence Address: SUGHRUE MION, PLLC, 2100 PENNSYLVANIA AVENUE, N.W., WASHINGTON, DC, 20037, US

(21) Appl. No.: 10/203,945

(22) PCT Filed: Feb. 15, 2001
(86) PCT No.: PCT/FR01/00446

(30) Foreign Application Priority Data
Feb. 18, 2000 (FR) 0001989

(51) Int. Cl. B05D 3/10; B05D 3/02

(52) U.S. Cl. 427/376.2; 427/327

(57) ABSTRACT

The invention concerns a method which consists in: providing a protective treatment against corrosion to the initial sheet metal using an aqueous emulsion containing colloids based on acrylic and/or methacrylic polymer; a step which consists in applying a coat of liquid enamelling composition comprising an enamel frit capable of being vitrified; a baking step adapted to vitrify said frit. The invention is characterised in that said method does not comprise a step for degreasing said surface subsequent to the protective treatment. The invention provides the advantages of improved adherence of the enamel and a simpler process.

The invention relates to a process for manufacturing a metal part coated with vitrified enamel from at least one metal sheet, comprising:

a corrosion-protection treatment of said metal sheet, in which a liquid aqueous corrosion-protection emulsion coating is applied to the surface of said metal sheet and then said coating is dried;

after the protection treatment, at least one step of applying a coat of enameling composition, comprising a vitrifiable enamel frit, to the surface to be enameled; and

at least one baking step suitable for vitrifying said frit of this composition.

Patent EP 577 486 (Sollac) describes such a (temporary) corrosion-protection treatment, which is moreover conventional.

In a manner known per se, the enameling composition may be applied as a powder or as a liquid.

In the case of metal parts made of steel, during the enamel baking step the part is generally heated to between 500 and 900° C., preferably between 560 and 850° C., the lowest temperature being reserved more for enamels in contact with low-melting-point surfaces such as those rich in aluminum, as in the case of aluminized steels.

According to known variants applied to the production of enameled metal sheets, this production process may have the following sequences:

application of a first coat of enameling composition/baking of the first coat/application of a second coat of enameling composition/baking of the second coat: this is what is referred to as the “two-coat, two-bake process;

application of a first coat of enameling composition followed by a second coat of enameling composition/simultaneous baking of the two coats: this is what is referred to as the “two-coat, one-bake” process;

application of a single coat of enameling composition/simultaneous baking of the single coat: this is what is referred to as the “one-coat, one-bake” or “direct-on enameling” process.

To ensure good adhesion of the enamel to the metal sheet, before the first coat of enameling composition is applied, treatment operations are generally performed on the surface to be enameled, for example a nickel-plating treatment; in particular in the case of direct-on enameling, a pickling treatment is even carried out before the nickel plating.

To ensure that these various operations are effective, it is generally necessary beforehand to strip the dried corrosion-protection coating with which it is coated from the surface of the metal sheet; this prior step constitutes a degreasing operation.

The object of the invention is to avoid this degreasing operation.

If the enameled part to be manufactured has a complex shape, this production process may include at least one forming operation performed on the metal sheets or blanks from these metal sheets, for example by drawing, which then in general requires beforehand a lubricating operation performed on the surface of the metal sheets, thereby reinforcing the need for subsequent degreasing.

The object of the invention is also to avoid this additional lubricating operation before forming, so as to avoid any degreasing operation.

This process for producing enameled parts may include welding or bonding operations performed on several sheet metal elements, which also require the surface to be cleaned.

The object of the invention is also to avoid the degreasing operations before assembly, especially by welding or bonding.

To recapitulate, the object of the invention is to avoid any degreasing operation after the corrosion-protection treatment.

For this purpose, the subject of the invention is a process for manufacturing a metal part coated with vitrified enamel from at least one metal sheet, comprising:

corrosion-protection treatment of said metal sheet, in which a liquid aqueous corrosion-protection emulsion coating is applied to the surface of said metal sheet and then said coating is dried;

after the protection treatment, at least one step of applying a coat of liquid enameling composition, comprising a vitrifiable enamel frit, to the surface of the metal sheet to be enameled;

at least one baking step suitable for vitrifying said frit of this composition applied to said surface; characterized in that:

said process does not include a step of degreasing said surface after the protection treatment;

said emulsion comprises an aqueous phase and colloids based on an acrylic and/or methacrylic polymer.

The emulsion that can be used to implement the invention may be prepared in a convention manner, for example as described in patent application WO 96/37554 (Henkel).

Preferably, the protection coating is applied and dried so as to obtain a dried coating weight of between 0.5 and 6 g/m², preferably greater than or equal to about 1 g/m² and less than or equal to about 3 g/m²; the dried protection coating is then thin enough not to have to be removed by degreasing before the enameling composition is applied, but thick enough to provide effective corrosion protection.

A conventional liquid enameling composition is used, the enamel frit of which generally has a softening temperature between about 400° C. and about 600° C.

This enameling composition is applied to the surface still coated with the dried protection coating, and therefore not degreased; the application conditions are adapted in a manner known per se in order to obtain a dried coat of enameling composition having a thickness generally between 150 and 350 μm; this composition is applied in a conventional manner, for example by dipping or spraying.

Next, the metal sheet or the part coated with enameling composition is baked; the baking conditions are adapted in a manner known per se so as to vitrify the enamel frit of the composition.

An enameled metal sheet or part is thus obtained according to the invention.

Surprisingly, by using an acrylic or methacrylic polymer for the corrosion protection, although the dried protection coating was not removed by degreasing before applying the coat of enameling composition, the enamel coat obtained, which coats the metal sheet or the sheet metal part, is of good quality, exhibits no enamel shrinkage defects, suitably wets the entire surface to be enameled and strongly adheres to the sheet metal substrate.

As the dried protection coating is not removed before applying the coat of enameling composition, it is no longer essential for the dried protection coating to be easily removable or “degreasable”; the step of corrosion-protection treatment according to the invention may therefore be, depending on the case, a “temporary” or “non-temporary” treatment step; in the dried corrosion-protection coating, the polymer may therefore be in the uncrosslinked state (and the dried coating is “degreasable”), or the partially crosslinked state or the completely crosslinked state (and the dried coating is not degreasable).

Other variants of the invention will now be described.

If the manufacture of the enameled part requires a forming step, especially a drawing step, any prior lubricating operation may be dispensed with provided that a polymer emulsion having lubricating properties is used, such as those described in patent EP 606 257 or EP 421 250 (PPG) or in patent application JP 82 108114 A.

To obtain this prelubricating effect, polymer emulsions containing at least 0.1% lubricant by weight with respect the weight of polymer are therefore used; the lubricant used may be a hydrocarbon wax, a beeswax, a carnauba wax, a mineral oil, for example petroleum, a vegetable or animal oil containing fatty acid esters, or a fatty acid.

By using such emulsions exhibiting lubricity, no lubricating operation is then necessary after the protection treatment and before the forming operation; the dried protection coating must then be sufficiently thick and contain enough lubricant to provide the desired lubricating effect: thus, using these lubricating emulsions of the prior art, it is recommended that:

the weight of this dried coating is greater than 0.5 g/m²;

the proportion by weight of lubricant with respect to the weight of polymer is greater than 0.1%, generally greater than 5%.

The drawback with such protection emulsions exhibiting lubricity is that the dried protection coating applied to the metal sheet was a greasy character.

The object of the invention is also to avoid the metal sheet corrosion-treated and lubricated in this way having a greasy appearance.

For this purpose, the subject of the invention is also a process for manufacturing an enameled part of the aforementioned type in which the protection emulsion of polymer colloids has the following characteristics:

the emulsion contains at least 0.7% by weight of at least one cosolvent other than water;

said colloids contain at least 0.1% by weight of oil;

the mean size of said colloids is less than 1000 nm.

Preferably:

said cosolvent is chosen from the group comprising ethanol, hexadecane and polyalkylene glycols;

the proportion of lubricant in the colloids is greater than or equal to 1% and less than 5% with respect to the weight of said polymer, 1% corresponding to the minimum amount for obtaining a sufficiently pronounced lubricating effect so as to be able to draw the metal sheet without a prior lubricating operation and 5 % corresponding to the amount above which there is a risk of the dried coating having a greasy appearance;

the monomer units of said polymer include at least one monomer M1, chosen from the group comprising acrylic acid esters and methacyrlic acid esters, and at least one acrylic or methacrylic monomer M2, having an acid, amide or amine group, the monomers M1 and M2 representing at least 30% of the total weight of said polymer and the at least one monomer M2 representing less than 25% of the total weight of said polymer; according to a variant, the monomer units of said polymer also include at least one ethylenically unsaturated copolymerisable monomer M3 other than an acrylic acid ester and a methacrylic acid ester;

in the formulation of said polymer, the proportion of the various monomers is adapted so that its glass transition temperature T_{g} is such that: −40° C.<T_{g}<+20° C.

Through these preferences, a dried coating is obtained which is sufficiently lubricating to allow drawing, sufficiently flexible to be deformed without rupturing after forming, and having sufficient coverage to provide effective corrosion protection; in addition, the dried coating does not have a greasy character.

A major advantage of the emulsions, the colloids of which incorporate a lubricant and have a mean size of less than 1000 nm owing to the presence of a cosolvent and to said lubricant, is that they are much more stable than the abovementioned lubricating emulsions of the prior art, thereby making them easier to apply to the metal sheet and allowing a protection coating to be obtained which is both thin and homogeneous.

To prepare the lubricating and non-greasy protection emulsion, the colloids of which incorporate a lubricant and the mean size of which is less than 1000 nm, the following monomers are preferably used:

at least one monomer Ml chosen from acrylic acid esters, like n-propyl acrylate, isobutyl acrylate, n-butyl acrylate (BuA), sec-butyl acrylate, tert-butyl acrylate, n-hexyl acrylate or lauryl acrylate (LA), and/or from methacrylic acid esters, like methyl methacrylate (MMA), ethyl methacrylate, n-butyl methacrylate, isobutyl methacrylate, sec-butyl methacrylate, tert-butyl methacrylate, n-hexyl methacrylate, cyclohexyl methacrylate, ethylhexyl methacrylate (EHMA) and lauryl methacrylate.

These esters may include one or more “hydroxyl” functional groups, such as hydroxyethyl methacrylate or hydroxypropyl methacrylate, or one or more “epoxy” functional groups, such as glycidyl methacrylate, or else one or more “amine” functional groups or one or more “nitrile” functional groups;

at least one monomer M2 chosen from monomers having an acid group, such as acrylic acid (AA), methacrylic acid, itaconic acid, maleic acid or fumaric acid.

The proportion of monomer M2 must remain sufficiently low:

so that the lubricant used for the preparation remains miscible in the monomer mixture, that is to say “compatible” with this organic mixture;

in order to retain good tribological properties, these being provided in particular by the polymer M1.

Thus, in practice, the proportion of monomers M2 remains less than 25% by weight of the organic mixture to be emulsified.

To prepare this lubricating and non-greasy protection emulsion, it is also preferable to use an ethylenically unsaturated polymerisable monomer M3 other than an acrylic or methacrylic ester, preferably chosen from a vinyl monomer such as styrene, methylstyrene or vinyl toluene.

Table I below gives the monomers used for the trials, together with the glass transition temperature T_{gM} of the corresponding homopolymers, used to calculate the glass transition temperature T_{g} of the polymer obtained in the emulsion according to the invention.

TABLE I
Monomer abbreviations

| Abbreviation | Monomer name | T_{gM} | Monomer family |
|---|---|---|---|
| BuA | Butyl Acrylate | −54° C. | Acrylic ester |
| | | | (M1) |
| LA | Lauryl acrylate | −3° C. | Acrylic ester |
| | | | (M1) |
| MMA | Methyl | +105° C. | Methacrylic ester |
| | methacrylate | | (M1) |
| EHMA | 2-Ethylhexyl | −10° C. | Methacrylic ester |
| | methacrylate | | (M1) |
| AA | Acrylic acid | +109° C. | “acid group” (M2) |
| NMA | Hydroxy- | +166° C. | “amide functional |
| | methylacrylamide | | group” |
| DMAEMA | Dimethylamino- | +19° C. | “amine functional |
| | ethyl | | group” |
| | methacrylate | | |

The proportions of the various monomers M1, M2, and optionally M3, in the composition are adapted in a manner known per se with a view to obtaining both good film-forming properties of the emulsion and a glass transition temperature (T_{g}) of the polymer between −40° C. and +20° C.

The good film-forming properties of the emulsion are those which allow a thin film of uniform thickness to be applied to a substrate; the film must be thin so as to be able to have a dry appearance and must be uniform so as to be effective against corrosion.

If the glass transition temperature of the film is below about 0° C., the thin film is generally flexible and strong enough to provide effective corrosion protection above about 0° C.; it has been found that, in particular when a polyalkylene glycol is incorporated into the film as cosolvent, these film properties are retained even if T_{g} is above 0° C., provided that T_{g} remains below about 20° C.

If T_{g} were to be above 20° C., there would be a risk of the film-forming character and the tribological properties deteriorating.

The so-called Fox-Flory equation is used to relate the glass transition temperature T_{g} of a heteropolymer to the proportions of monomers in this polymer;

1/T_{g}=Σ(W_{M}/T_{gM})

where W_{M} is the mass fraction of the monomer M in the polymer and T_{gM} is the glass transition temperature of the homopolymer corresponding to the monomer M.

To prepare the lubricating and non-greasy protection emulsion, a lubricant is therefore also used, not only to obtain lubricating properties but to obtain, during synthesis of the emulsion, a “co-surfactant” effect allow the stability of the emulsion to be improved.

To obtain a sufficiently stable treatment emulsion having colloids whose mean diameter is less than 1000 nm and being effective in terms of corrosion resistance and lubrication, it is recommended to add at least 0.1%, preferably at least 1%, of lubricant relative to the mass of the organic starting phase.

To obtain a treatment film of dry appearance, it is necessary for almost all of the lubricant added to the organic starting mixture to be able to be incorporated into the colloids of the emulsion under the physical and chemical conditions for emulsifying this mixture so that, in particular, the acrylic polymer colloids of the emulsion obtained contains this lubricant; in this way, the emulsion obtained does not have a greasy appearance when it is applied as a thin film; in practice, the amount of lubricant, relative to the mass of monomers of the organic starting mixture or to the organic phase of the emulsion obtained, thus remains less than 5%.

It is possible to use, as lubricant, natural oils of the animal, vegetable or mineral (petroleum) type or synthetic oils; for the trials below, liquid paraffin (abbreviated to “paraf”) or a QUACLAD® oil with the reference N8021 from Quaker (abbreviated to “Q.N8021”) or castor oil (abbreviated to “castor”), which is essentially composed of a triglyceride of ricinoleic acid, are used.

To prepare the lubricating and non-greasy protection emulsion, an emulsion polymerization of the monomer mixture is carried out; thus, to prepare this emulsion, and then polymerize it, the following are also used:

an organosoluble radical polymerization initiator, which can generally be thermally activated; for example, an initiator belonging to the family of peroxides or to that of azo compounds is chosen; the initiator used in the trials is 2,2′-azobis(isobutyronitrile) (AIBN), which is active from about 60° C. upwards;

at least one surfactant for emulsifying the organic phase in the aqueous phase: in the trials, a mixture of a non-ionic surfactant, such as polymethyl methacrylate-polyethylene oxide (PMMA-PEO), and of an ionic surfactant, such as sodium dodecylsulfate (SDS), is used; this mixture of emulsifying agents allows particularly stable treatment emulsions to be obtained, even at high shear rates such as produced therein when the treatment emulsion is applied by spraying; the use of an emulsifier prepared by grafting acrylic acid onto oils, as described in the document GB 2 007 237, would not allow the required stability to be obtained.

In order for the polymer emulsion obtained to be sufficiently stable during storage (zero shear rate) and under the application conditions (high shear rate) and for it to be uniformly applicable as a thin film, especially with a weight as low as 0.5 g/m², the mean size of the colloids should remain less than 1000 nm, preferably less than or equal to 500 nm; the emulsions according to the invention thus belong to the “miniemulsions” category as defined below.

In general, emulsions are classified in three broad categories depending on the size of their colloids:

conventional emulsions, also called “macroemulsions”: these are generally prepared by mixing two immiscible liquids with one or more ionic or non-ionic surfactants or a mixture of these two types; the emulsion obtained is in the form of droplets of the order of a micrometer in size; macroemulsions are opaque, milky in appearance and have a tendency to settle during storage;

“microemulsions”: they are prepared by using a mixture of surfactants with a cosurfactant, generally a mixture of ionic surfactants with a short-carbon-chain alcohol (of the pentanol or hexanol type); microemulsions are thermodynamically stable dispersions of oil in water, or conversely water in oil, which have spherical droplets or colloids whose diameter is less than one quarter of the wavelength of visible light, i.e. of the order of 10 to 1000 nm; because of this small size, the microemulsions are translucent or even transparent;

“miniemulsions”: they are prepared by using a mixture of ionic and/or non-ionic surfactants with a cosurfactant such as a fatty alcohol or a long-carbon-chain alkane; it is also accepted that miniemulsions have two broad characteristics: high stability and particle or colloid size generally between 50 and 1000 nm, preferably between 50 and 500 nm; miniemulsions are opaque fluids of milky appearance.

The acrylic polymer of the lubricating and non-greasy protection emulsion is therefore formed by miniemulsion polymerization, in order to obtain an emulsion more stable and easier to apply than when a conventional emulsion polymerization of the macroemulsion type is carried out; thus, to prepare this miniemulsion, a cosurfactant and a cosolvent are also used;

as cosurfactant, the oil already described is used, according to the invention, as the component of the organic starting mixture or as the component incorporated into the acrylic polymer colloids of the emulsion obtained; other conventional cosurfactants may be added;

the term “cosolvent” is understood to mean a non-aqueous solvent miscible in water; as cosolvent, ethanol or hexadecane may be used; preferably, in order to improve the lubrication properties of the emulsion according to the invention, a polyalkylene glycol is used as cosolvant.

The lubricating and non-greasy protection emulsion may also contain other additives: for example, other surfactants to promote wetting of the surface to be treated, antifoams, corrosion inhibitors, bactericides, odorizers, dyes or pigments.

The corrosion inhibitors may for example be chosen from:

(1) salts of acids and salts of amines;

(2) salts of optionally ethoxylated and/or phosphated fatty alcohols;

(3) zinc salts of carboxylic, optionally fatty, acids;

(4) alkanolamine borates and/or phosphates;

(5) aluminium or zinc phosphates.

Examples of inhibitors are given in Table II below, these being denoted by their commercial reference, with the name of the company that markets them, the abbreviation subsequently used to denote them, their essential components denoted by a number (1) to (5) with reference to the above list, and their main characteristics.

TABLE II
Corrosion inhibitors

| | Commercial | | Composition/- |
|---|---|---|---|
| Abbreviation | Reference | Company | characteristics |
| BBA | EMADOX BBA | Labema | (4) borate/ |
| | | | lubricating |
| NB | EMADOX NB | | (4) borate + |
| | | | phosphate/ |
| | | | adhering |
| 3059E | 3059E | Sidobre | Emulsifiable |
| | | Sinnova | polyamine |
| RC305 | IBDA RC305 | Croda | (4) borate |
| I 252 | IRGACOR 252 | Ciba | (3) hydrophobic |
| | FC | | compounds |
| I 1405 | IRGACOR 1405 | | |
| I 1930 | IRGACOR 1930 | | |
| S379 | SET AD FA 379 | Condea- | (1)/adhering |
| | | Servo | effect |

The polymers of the lubricating and non-greasy protection emulsions were prepared, in a manner known per se, by radical emulsion polymerization in the presence of a radical initiator; according to the invention, the lubricant is added to the organic starting mixture before emulsification, unlike the process described in the aforementioned JP 82 108114 A.

The preparation of this emulsion is carried out as follows:

1/preparation of the organic starting phase: the following is prepared, in the intended proportions: an organic mixture of monomers, comprising M1, M2 and optionally M3, of the lubricant in predetermined proportions and finally the organosoluble initiator; the mixing is carried out with stirring in order to obtain a homogeneous organic phase; as stirring means, is possible to use, for example, mechanical means or ultrasound.

The mixture preparation conditions, such as temperature and the method of stirring, should be adapted in order to avoid, or at the very least limit, polymerization initiation at this stage; thus, if the initiator is AIBN, which is active as soon as the temperature exceeds 60° C., it is recommended;

to keep the mixture at a temperature well below 60° C.;

to adapt the stirring means so as to limit the heat-up of the mixture to well below 60° C.; thus, it is preferable to stir by mechanical means rather than by ultrasound.

2/preparation of the aqueous phase: the surfactant or surfactants are dissolved in demineralized water; in this method of implementation, neither a cosolvent nor a cosurfactant is introduced at this stage;

3/next, the miniemulsion of the organic phase in an aqueous phase is performed conventionally, for example in the following manner: the organic phase is added drop by drop to the aqueous phase, with stirring, and then, again with stirring in order to homogenize the mixture, one or more cosolvents and, optionally, one or more cosurfactants are added, optionally under conditions suitable for forming a miniemulsion whose organic colloids or droplets have a diameter of less than 1000 nm, preferably less than or equal to 500 nm, and therefore less than the thickness of the dry protection film to be formed.

The addition of cosurfactant is optional because, according to the invention, the oil of which the organic starting phase is composed already acts as cosurfactant; other conventional cosurfactants may be added at this stage, such as a fatty alcohol or a long-carbon-chain alkane, the number of carbon atoms of which is greater than or equal to 10.

According to a variant of the invention, the cosolvent is added to the aqueous phase before the step of forming the miniemulsion; a water-miscible cosolvent in the required proportions is chosen.

The stirring and homogenizing conditions for forming the emulsion amount to “physical” preparation conditions, whereas the nature and the proportions of surfactants and cosurfactants, such as the oil in the organic starting phase, and of cosolvants amount to “chemical” preparation conditions; these physical and chemical conditions are adapted in a manner known per se in order to be able to form the miniemulsion according to the required colloid size and emulsion stability criteria.

Thus, for stirring and/or homogenizing, it is possible to use a turbine of the ULTRA-TURAX® type so as to shear the mixture at high speeds.

The size of the colloids obtained may be controlled by conventional measurements based on quasi-elastic light scattering.

At this stage of the preparation, it is very important that the lubricant of the organic starting phase be incorporated into the colloids and be suitably distributed therein; if the proportion of lubricant exceeds what is termed as a compatibility limit, for a given organic starting mixture and given emulsifying conditions, two different populations of colloids will appear after emulsification and the treatment composition resulting from this emulsion does not allow a “dry”, that is to say non-greasy, protection film to be obtained.

The distribution of the colloids of the emulsion as a function of their size may be determined by conventional measurements, such as measurements based on quasi-elastic light scattering; this distribution curve makes it possible to determine whether the emulsion has;

a single homogeneous population: the distribution curve has only a single maximum;

several populations: the distribution curve has several maxima.

The presence of a single population in the emulsion indicates that the lubricant has been incorporated into the colloids in accordance with the invention; if this is not the case, the presence of two separate populations in the emulsion indicates that the lubricant has not been incorporated into the colloids;

4/next, the emulsion polymerization is carried out in a conventional manner, for example as follows: initiator activation conditions are applied to the miniemulsion obtained; if the initiator can be activated thermally, the miniemulsion is heated to above the activation temperature of the initiator, in this case for AIBN between 60° C. and 100° C.; the emulsion is kept under these conditions for the time needed to obtain the polymerization, in this case about 24 hours; during this time, the emulsion is deoxygenated using a stream of nitrogen.

A miniemulsion of acrylic or methacrylic polymers is then obtained, this being ready to use, optionally by diluting it with water, in order to treat a surface, and being able to form, on this surface, a thin dry coating which is both protective and lubricating.

As indicated above, other additives may be incorporated into the mixture intended to form the miniemulsion or at a subsequent stage of the preparation, or else into the ready-to-use emulsion; corrosion inhibitors are especially used, for example about 10 g/l of at least one of the inhibitors mentioned in Table II.

The aqueous emulsion obtained is therefore stable, fluid and uniform; the dispersed polymer particles generally have a mean diameter between 50 and 1000 nm; the solids content of the dispersion is generally between 10 and 50%, for example around 18%, with respect to the total weight of the emulsion.

The glass transition temperature (T_{g}) of the polymeric solid phase of the emulsion may be determined, for example by differential scanning calorimetry; this temperature depends essentially on the nature and the proportions of the monomers, as indicated above; the addition of a lubricant generally has the effect of lowering this glass transition temperature; thus, the influence of the proportion of lubricant on the glass transition temperature is also a means of checking the incorporation of this lubricant into the colloids; the absence of influence may be the indicator of the absence of incorporation of the lubricant into the colloids: conventional T_{g} values obtained are: −40° C., −20° C., 0° C. and 20° C.

Other advantages of the process of the invention will become apparent from reading the examples presented below as nonlimiting illustrations of the present invention.

Materials:

1) Metal Sheet

A hot-rolled or cold-rolled steel may be used; a bare steel sheet suitable for enameling, with the commercial name E 310, having a thickness 1.7 mm is chosen here.

2) Temporary Corrosion-Protection Emulsion:

2.1—Neat oil and reference emulsions, for comparative trials: the emulsions are prepared by emulsifying, and diluting in water, oily bases with the references indicated in Table I; neat Quaker 8021 oil is applied as it is.

The metal surface to be treated must be clean, free of dirt and traces of oil; the emulsion may be applied after the pickling line.

If the pH of the emulsions obtained is not between 7 and 11, it is preferable to adjust it so as to obtain a pH between 7 and 11, so as to avoid any risk of corrosion of the substrate by the emulsion.

Application of the emulsion to the surface of the metal sheet to be corrosion-protected may be carried out by spraying, dipping, coating or even spin-coating; after application, the coating deposited is dried at a temperature generally between 40° C. and 150° C., for example by hot-air blowing.

To apply the neat oil, electrostatic spraying is used.

The application and drying conditions are adapted so as to obtain the weight indicated in Table III.

TABLE III
Oily bases for temporary protection emulsions

| Emulsifiable oily | | |
|---|---|---|
| base; supplier and | Degree of | |
| commercial | dilution | Dry weight |
| reference | % | (g/m²) |
| Quaker 8021 | Neat oil | 1 |
| Castrol AQUABEIGE | Already | 1.5 |
| | prediluted | |
| Quaker 200 BF | 15% | 1.5 |
| Castrol AQUASAFE 21 | 5% | 0.5 |

2.2—Emulsion for Implementing the Invention:

To mix the monomers and the lubricant by mechanical stirring, the following organic phase is prepared:

Butyl acrylate: 74.8 g;

Methyl methacrylate: 24.2 g;

Acrylic acid: 11 g;

Liquid paraffin: 2.75 g;

AIBN as initiator: 2.2 g

The following aqueous phase is also prepared:

demineralized water: 500 g;

8.25 g of PMMA/PEO and 0.5 g of SDS as surfactants;

75 ml of ethanol as cosolvent.

Starting from this organic phase and this aqueous phase, a lubricating and non-greasy temporary protection emulsion is prepared, using the general emulsion preparation and polymerization method that has just been described.

An emulsion of acrylic and methacrylic polymers containing about 18% by weight of solids is obtained, this having the following characteristics:

the emulsion contains 10% by weight of cosolvent, in this case ethanol;

the colloids of this emulsion contain about 2.5% oil by weight;

the mean size of said colloids is less than or equal to 500 nm.

Corrosion inhibitors are added to the emulsion obtained, namely 10 g/l of BBA and 10 g/l of S379 (see Table II for the meaning of the abbreviations).

The emulsion obtained is then ready to use for the protection treatment of the process according to the invention; after application and drying under conditions suitable for obtaining a dried coating with a weight of about 2 g/m², the treated surface of the metal sheet does not have a greasy appearance.

The drying may be carried out at a temperature low enough to prevent the polymer of the emulsion crosslinking, so that the dried coating can be easily removed by a conventional degreasing operation and so that the protection thus conferred is thus temporary in character; the drying may be carried out at a higher temperature so as to at least partially crosslink the polymer in the protection coating, since it does not need to be removed by degreasing in order to implement the invention.

3—Enameling Compositions:

Three compositions were used for the tests, summarized in Table IV.

TABLE IV
Metal enameling compositions

| Supplier and | | | |
|---|---|---|---|
| commercial | | Mode of | Softening |
| reference | Presentation | application | temperature |
| Ferro MS502B | Liquid | Dipping | 430° C. |
| | (slip) | Spraying | |
| Pemco | Liquid | Dipping | 480° C. |
| 63/55/13/25 | | | |
| Pemco | Solid | Spraying | (>400° C.) |
| PP800M62037 | (powder) | | |

Methods:

1) Tribological Tests:

A flat-on-flat tribometer of a type known per se is used for the tribology tests.

After temporary corrosion-protection treatment but without additional oiling, the specimens of metal sheet to be tested are clamped with a clamping force Fs between two small plates 1 cm² in area made of high-speed steel.

The friction coefficient k is measured whilst moving the specimen at a constant speed V with respect to the plates over a total travel D of 180 mm, while progressively increasing the clamping force Fs from 200 daN at the start of the test to 2000 daN at the end of the test.

The pull speed V is 10 mm/s.

The curve of variation of friction coefficient k as a function of time or of the clamping force Fₛ is generally decreasing, more rarely constant; to evaluate the tribological properties, the friction coefficient μ_{F} at the end of the curve, for Fₛ≈1800 daN, is generally measured.

2—“Damp-heat” (or “damp” or “FKW”) Corrosion Test:

After temporary corrosion-protection treatment, the specimens of metal sheet to be tested are placed as they are in an environmental chamber, which corresponds to DIN standard 50017 published in October 1982 and simulates the corrosion conditions of the outermost turn of a sheet-metal coil or of a cut sheet of metal during storage.

The environmental cycle that the specimen to be tested undergoes is as follows:

8 h at 40° C. and 95 to 100% humidity/16 h at 20° C. and 75% relative humidity.

The result of the test is obtained by recording the number of successive cycles before four corrosion pits appear on the specimen.

3—“Transport” Corrosion Test

The specimens to be tested are placed in an environmental chamber in tight packets of 4 specimens, which simulates the corrosion conditions in the core of a sheet-metal coil during a transportation step.

The environmental cycle that the packet of specimens to be tested undergoes is the following: 10 h at 40° C. and 95% humidity/4 h at 20° C. and 85% humidity/10 h at −5° C. and 0% humidity/8 h at 30° C. and 85% relative humidity.

The result of the test is obtained by recording the number of successive cycles before the surface of the specimen becomes slightly stained because of corrosion.

4—Degreasability Test:

To evaluate the degreasability (in %), a procedure in accordance with the Renault D691713/..C method is used.

After temporary corrosion-protection treatment, the specimens of metal sheet to be tested are subjected to the action of an alkaline degreasing bath under defined conditions.

The ability of the temporary protection coating to be degreased off or removed is assessed on the basis of the degree of wetting of the specimen after cleaning.

The degreasing bath has the following composition:

Demineralized water;

Sodium metasilicate (35 g/l);

Trisodium phosphate (16 g/l);

Ethoxylated (to 10 mol) nonylphenol 4 g/l;

Nitriloacetic acid (2 g/l).

The specimen to be tested is completely immersed in this bath at 60° C. for 3 minutes; the specimen is then washed in a bath of ordinary water for one minute and then under a jet of water for 30 seconds.

After rinsing, by inclining the specimen at 45°, the percentage of the surface that is wetted after 30 seconds of draining is estimated.

Surfaces on which there is no break in the film of water are considered as being 100% degreased; otherwise the percentage of dewetting is noted by subtracting it from 100%.

5—Test for Wetting of the Metal Sheet by the Liquid Enameling Slip

The enameling compositions are applied in solid (powder) or liquid (slip) form.

After temporary corrosion-protection treatment (except for the “degreased sheet” control specimen), the specimens of sheet to be tested are coated with slip.

The wettability results obtained are classified as poor (−−), mediocre (−), acceptable (o), good (+) and excellent (++); the classification corresponds to a visual assessment: good wettability is manifested by the slip being well attached to the specimen, whereas poor wettability is manifested by a sliding effect of the slip on the specimen.

6—Behavior During Enamel Vitrification Baking and Assessment of the Enamel Coat Obtained

After temporary corrosion treatment and after applying, by dipping or spraying, a coat of enameling composition with a dry thickness of 150 to 350 μm, the specimens obtained are baked under conditions suitable for vitrifying the frit of the enameling composition, so as to obtain an enameled specimen.

The result of the test consists in observing any anomalies which occur during baking or which are found after baking on the enameled surface, like the problem of enamel shrinkage, which corresponds to poor wettability of the surface by the frit, or like the problems of bubbling or foaming.

7—Adhesion of the Enamel Coat Obtained to the Sheet

The adhesion test consists in measuring the impression made by a 20 mm diameter steel ball in contact with the enameled surface of the steel, when a mass weighing 7.5 kg is dropped vertically and freely onto this ball from a height of 90 cm.

The impression obtained on the enameled surface is then given a rating according to a grading chart published by The Institute of Vitreous Enamelers, entitled “Visual classification of adhesion of vitreous enamel to steel”: poor (−−), mediocre (−), acceptable (o), normal (+), and good (++).

### EXAMPLE 1

Comparative Tests Before Enameling: Corrosion Resistance, Degreasability and Tribological Properties Provided by Various Emulsions

The tests described in the METHODS section are used to compare the corrosion resistance provided by the various emulsions applied to the steel sheet as described in paragraph 2) of the PRODUCTS section, and their degreasability and their tribological properties. The results are given in Table V.

TABLE V
Effects of the temporary corrosion treatment

| | FKW | Transport | Degreasa- | Friction |
|---|---|---|---|---|
| Emulsion | Corrosion | corrosion | bility | μ_{F} |
| Quaker 8021 | >30 | >20 | 100% | 0.14 |
| | cycles | cycles | | |
| Castrol | 10 cycles | 4 cycles | 100% | 0.15 |
| AQUASAFE 21 | | | | |
| Castrol | 10 cycles | — | 100% | 0.07 |
| AQUABEIGE | | | | |
| Quaker 200 BF | — | — | — | 0.11 |
| Acryl. polym.* | 18 cycles | 12 cycles | 100% | 0.06 |

*Acryl. polym. denotes the polymer emulsion described at 2.2 in the above PRODUCTS section.

It may therefore be seen that only the emulsion of the prior art, Castrol AQUABEIGE, and the “Acryl. polym.” emulsion specific to the invention reduce the friction substantially to the point of providing a lubricating effect.

### EXAMPLE 2

Comparative Tests During and After Enameling: Wetting of the Sheet Treated with the Liquid Enameling Slip, Behavior During Enamel Vitrification Baking, Assessment of the Enamel Coat Obtained and Adhesion of the Enamel Coat

Case of Dip Application of a Liquid Enameling Composition

The tests described in the METHODS section are used to compare the enamelability properties, mentioned by way of example, of specimens corrosion-treated with various emulsions, to which the Ferro enamel slip MS502B was applied by dipping; the results obtained are given in Table VI.

TABLE VI
Enamelability with dip-applied Ferro MS502B

| | Slip | Baking: enamel | |
|---|---|---|---|
| Emulsion | wetting | obtained | Adhesion |
| None (cleaned | + | Good | + |
| sheet) | | | |
| Quaker 8021 | + | Enamel shrinkage | + |
| Castrol | − − | Enameling impossible | + |
| AQUASAFE | | | |
| Castrol | − − | Substantial | + |
| AQUABEIGE | | bubbling, blackening | |
| | | of the enamel | |
| Quaker 200 BF | − | Enamel shrinkage | + |
| Acryl. polym. | + | Good | + + |

The enamelability properties of specimens corrosion-treated with various emulsions, to which the Pemco 63/55/13/25 enamel slip was applied by dipping, are then compared in the same way; the results obtained are given in Table VII.

TABLE VII
Enamelability with Pemco 63/55/13/25 applied by dipping

| | Slip | Baking: enamel | |
|---|---|---|---|
| Emulsion | wetting | obtained | Adhesion |
| None (cleaned | + | Good | + |
| sheet) | | | |
| Quaker 8021 | + | Enamel shrinkage | + |
| Castrol | ∘ | Enamel shrinkage | + |
| AQUASAFE 21 | | | |
| Castrol | + | Enamel shrinkage | + |
| AQUABEIGE | | | |
| Quaker 200 BF | − − | Enamel shrinkage | + |
| Acryl. polym. | + | Good | ++ |

Particularly good wettability of the surfaces corrosion-treated using the polymer emulsions according to the invention is observed, whether at room temperature as regards the wetting of the slip or at high temperature as regards wetting of the enamel above the softening temperature of the frit, although the protection coating had partly degraded.

It was found that this particular wettability of the surfaces treated by these polymer emulsions could be demonstrated at room temperature by simple comparative tests of the spreading of a drop of pure water on inclined supports: very similar wettability is thus observed for sheets whose surface has been cleaned and for sheets whose surface has been coated with a dried coat of polymer emulsion according to the invention, whereas on sheets whose surface was treated with the Quaker 8021 emulsion, the drop of water rolls off the inclined surface without wetting it.

### EXAMPLE 3

Comparative Tests During and After Enameling: Idem Example 2

Case of Spray Application of a Liquid Enameling Composition

As previously, the tests described in the METHODS section are used to compare the same enamelability properties as in Example 2 of specimens corrosion-treated with the same various emulsions as in Example 2, to which the liquid Ferro MS502B enamel slip was applied by spraying.

For all the emulsions tested, only Castrol AQUABEIGE did not allow wetting by the spray-applied slip.

Except with the specimens treated according to the invention by a polymer emulsion, all the vitrification baking operations gave rise to substantial enamel shrinkage, characteristic of lack of wetting by the hot liquid enamel.

The enamel degradation and blackening effect is also found when the enamel is applied to a dried coat of Castrol AQUABEIGE product; it seems in fact that this product degrades, leaving residues at higher temperature than the other emulsions.

These tests therefore confirm the advantageous behavior of surfaces treated using the polymer emulsion according to the invention, in particular as regards cold and hot wetting by the enamels applied in liquid form.

### COMPARATIVE EXAMPLE 1

Comparative Tests During and After Enameling: Idem Example 2

Case of Spray Application of a Solid Enameling Composition

As previously, the tests described in the METHODS section are used to compare the same enamelability properties as in Example 2 of specimens corrosion-treated with the same various emulsions as in Example 2, to which the Pemco PP800M62037 enamel powder was applied by spraying.

It is then found that, whatever the emulsion used, the enamelability results are correct:

in terms of wetting by the cold powder;

in terms of wetting during baking: no enamel shrinkage observed.

From these results it may be deduced that the effect of the invention relates specifically to enameling with compositions applied in liquid form.

1. A process for manufacturing a metal part coated with vitrified enamel from at least one metal sheet, comprising:
corrosion-protection treatment of said metal sheet, in which a liquid aqueous corrosion-protection emulsion coating is applied to the surface of said metal sheet and then said coating is dried;
after the protection treatment, at least one step of applying a coat of liquid enameling composition, comprising a vitrifiable enamel frit, to the surface of the metal sheet to be enameled;
at least one baking step suitable for vitrifying said frit of this composition applied to said surface; characterized in that:
said process does not include a step of degreasing said surface after the protection treatment;
said emulsion comprises an aqueous phase and colloids based on an acrylic and/or methacrylic polymer.

2. The process as claimed in claim 1, characterized in that said protection coating is applied and in that it is dried so as to obtain a dried coating weight of between 0.5 and 6 g/m².

3. The process as claimed in either of claims 1 and 2, characterized in that said emulsion includes a lubricant chosen from the group comprising waxes, mineral, vegetable, animal or synthetic oils, and fatty acids, the proportion by weight of lubricant with respect to the weight of polymer in emulsion being greater than 0.1%.

4. The process as claimed in claim 3, characterized in that it includes at least one forming operation carried out on said metal sheet, after said corrosion-protection treatment and before said enameling composition application step.

5. The process as claimed in claim 4, characterized in that it does not include a lubricating operation after the protection treatment and before the forming operation.

6. The process as claimed in either of claims 4 and 5, characterized in that said forming operation is a drawing operation.

7. The process as claimed in any one of claims 3 to 6, characterized in that:
said emulsion contains at least 0.7% by weight of at least one cosolvent other than water;
said colloids contain at least 0.1% by weight of said lubricant;
the mean size of said colloids is less than 1000 nm.

8. The process as claimed in claim 7, characterized in that, in said emulsion, the proportion of said lubricant is greater than or equal to 1% and less than 5% with respect to the weight of said polymer.

9. The process as claimed in either of claims 7 and 8, characterized in that said cosolvent is chosen from the group comprising ethanol, hexadecane and polyalkylene glycols.

10. The process as claimed in any one of the preceding claims, characterized in that the monomer units of said polymer include at least one monomer M1, chosen from the group comprising acrylic acid esters and methacrylic acid esters, and at least one acrylic or methacrylic monomer M2, having an acid, amide or amine group, the monomers M1 and M2 representing at least 30% of the total weight of said polymer and the at least one monomer M2 representing less than 25% of the total weight of said polymer.

11. The process as claimed in claim 10, characterized in that the monomer units of said polymer also include at least one ethylenically unsaturated copolymerisable monomer M3 other than an acrylic acid ester or a methacrylic acid ester.

12. The process as claimed in any one of the preceding claims, characterized in that the glass transition temperature T_{g} of said polymer is such that: −40° C.<T_{g}≦+20° C.
